(19) United States
(12) Patent Application Publication
(10) Pub. No.: US 2010/0118661 A1
(43) Pub. Date: May 13, 2010

(54) WATCH MOVEMENT AND WATCH

(76) Inventor: Jean-Francois RUCHONNET, Mont-Sur-Rolle (CH)

Correspondence Address: BLANK ROME LLP, WATERGATE, 600 NEW HAMPSHIRE AVENUE, N.W., WASHINGTON, DC, 20037, US

(21) Appl. No.: 12/688,053

(22) Filed: Jan. 15, 2010

Related U.S. Application Data
(63) Continuation of application No. PCT/EP2008/059403, filed on Jul. 17, 2008.

(30) Foreign Application Priority Data
Jul. 17, 2007 (CH) CH/01150/07

(51) Int. Cl. G04B 1/26

(52) U.S. Cl. 368/65

(57) ABSTRACT

Watch or watch movement comprising a regulating member and a display mechanism for displaying time data from the movement. The watch or watch movement also comprises a hydraulic system using oil or liquid to transmit forces and/or to lubricate the mechanism.

### CROSS-REFERENCE TO RELATED APPLICATIONS

This application is a continuation of PCT application No PCT/EP2008/059403 (WO2009/010568) filed in Jul. 17, 2008, the content of which is hereby incorporated.

### FIELD OF THE INVENTION

The present invention concerns a movement for a wristwatch and a wrist-watch.

### DESCRIPTION OF THE RELATED ART

Mechanical movements for wristwatches generally use gears to transmit forces or movements. Movements with belts or connecting rods for the transmission of movements over longer distances are also known.

However, gears do not allow forces to be easily transmitted towards an opposite point of the movement or from the movement's lower surface to its upper surface. Belts or connecting rods offer additional possibilities but have considerable space requirements. Furthermore, it is difficult to transmit great forces or torques with small-size mechanical elements.

Mechanical movements further require periodical lubrication in order to replace the oil that has moved or deteriorated. This operation is tedious and one is now attempting to banish oil completely from the movements, for example by improving the surface state of the parts or by using silicon parts. However, a correctly lubricated watch works better than a non-lubricated one, notably because of the lower wear and tear of the parts and of the reduction of friction.

### BRIEF SUMMARY OF THE INVENTION

The present invention thus strives to solve these problems with the aid of a watch, or at least of a watch movement, provided with a hydraulic system.

The hydraulic system can be used for example to transmit forces or torques from one point of the movement or of the watch to another. It can be used for example for replacing all or part of the gear-train, for animations on the dial or for complications. It is also possible to use a hydraulic system entirely or partly outside the case, associated for example to push-buttons, to the winding crown, to a cover, to a bottom or to the wristlet.

The hydraulic system can also be used for lubricating the watch movement, by bringing the oil where it is necessary. Instead of doing without the movement's oil, some is added.

By hydraulic system it is understood in the present application a system using a liquid fluid, for example lubricating oil. The fluid is preferably circulated, at least at some instants, in order to transmit a force or to lubricate the movement or other elements. The displacements can also be constituted by pressure variations applied to the fluid, for example by compressing or releasing it. The hydraulic system thus uses a fluid that goes through tubes and/or cylinders and/or pistons etc. unitedly connected to the movement or to the watch case.

The hydraulic system is preferably completely closed, in order to avoid unwanted losses of liquid when the watch is shaken or turned over. The system has to be adapted to a wristwatch. The wristwatch is preferably regulated by means of a conventional regulating member, for example a balance and spiral unit or a quartz oscillator; the hydraulic system is thus only involved for lubricating this regulating member (or other elements) and/or for transmitting forces within the movement and within the watch. The watch's accuracy is thus practically independent of possible dilatations or deteriorations of the liquid.

### BRIEF DESCRIPTION OF THE FIGURES

Examples of embodiments of the invention are indicated in the description illustrated by the attached figures in which:

FIG. 1 illustrates in the form of a bloc diagram an example of a hydraulic system according to the invention.

### DETAILED DESCRIPTION OF THE INVENTION

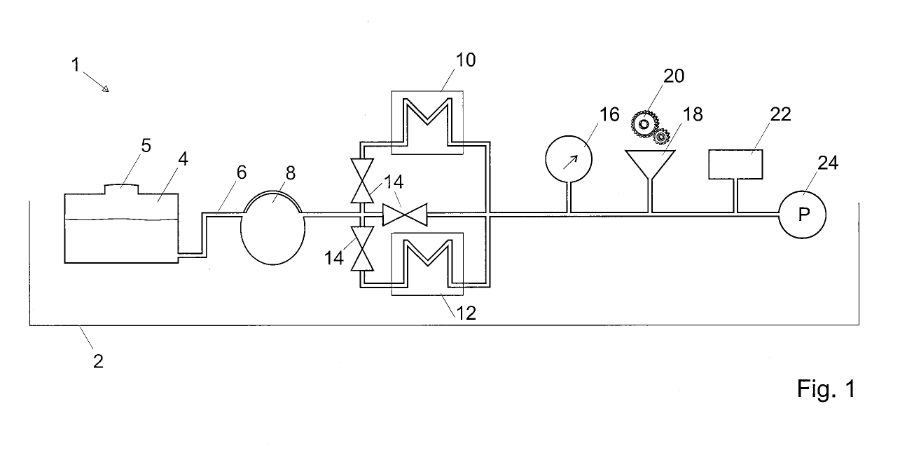

FIG. 1 represents diagrammatically a hydraulic system 1 for a watch or watch movement. All the components of this diagram are optional and non-essential to the invention. The system is preferably accommodated at least partly inside a watch case and firmly connected unitedly to the watch movement. The watch further comprises a display mechanism for displaying the movement's time indications, for example hands or a window display, not represented.

The system comprises an oil pan 2 to recover the oil exiting from the hydraulic system. The oil pan can be constituted of a bridge or a plate, or even by the watch's bottom. It is possible to use an open oil pan that recovers the oil only when the watch is worn in a usual position with the dial upwards. It is however important to ensure that the oil does not penetrate onto the dial or into other parts that can are visible.

An oil or liquid reservoir 4 preferably inside the watch case contains the fluid reserve necessary to the operation and/or lubrication of the movement. The reservoir can preferably be filled, for example without opening the watch or disassembling the movement, by introducing the oil through an opening closed off by a cap 5, for example a cap accessible from outside the watch case. The oil or liquid level can be displayed by an oil gauge, for example a gauge comprising a rotating or linear hand visible from outside the watch, for example on the dial or close to the bottom. An insufficient oil level can also be signaled with the watch hands or with another indicator of the watch.

In the present invention, a simple deposit of oil on a bearing, a staff or in a cylinder or piston for example is not considered as a reservoir; a reservoir designates a container designed to store a liquid used in another place.

The fluid circulates in the hydraulic system through the tubes 6, for example flexible tubes of metallic or plastic material or rigid tubes, for example of a metal such as steel, stainless steel, copper, brass or gold. Rigid ceramic or plastic tubes are also be contemplated. Tubes can be in the movement, around the movement, through the case or even go through the case or the dial. Advantageously, certain tubes can be visible through the wristwatch's glass; one will for example use transparent tubes enabling the flowing liquid, which can also be colored, to be seen.

Tubes, or other components of the hydraulic system, can also be made by micro-fluidic technologies, i.e. by machining recesses, valves etc. in a substrate of silicon or synthetic material with lithography or ion beam techniques for example.

An expansion tank 8 enables the pressure in the hydraulic system to be regulated automatically. The expansion tank includes for example a membrane that deforms according to the difference between the atmospheric pressure and the pressure of the liquid.

The viscosity of oil and of many liquids varies according to the temperature. This effect can be desirable because it allows for example the speed at which forces are transferred to be increased by heating the oil. In other cases, this effect is unwanted. Furthermore, the variation of temperature of the liquid can cause considerable dilatations, especially in a small-diameter tube.

In order to control the fluidity and dilatation of the liquid, the hydraulic system can comprise one or several heat exchangers 10, 12. In the illustrated embodiment, a first heat exchanger 10 close to the upper surface of the movement or close to the side of the case makes it possible to cool the liquid by having it circulate close to ambient air. A second heat exchanger 12 close to the bottom of the watch enables the liquid, on the contrary, to be heated with the body heat of the watch wearer. Valves 14 can be opened all-or-none or in a regulated fashion in order to circulate the fluid through one or the other heat exchanger or directly. The valves can be controlled manually by the watch user, by means of the watch movement, according to the liquid's dilatations or depending on the temperature for example.

The fluid's temperature can also be controlled by modifying its pressure, for example by compressing or easing/relaxing it.

A pump 24 makes it possible to circulate the liquid in the hydraulic system. The pump 24 is advantageously actuated by the watch movement, for example with the aid of the energy accumulated in the barrel. The liquid can circulate permanently when the watch is running, or only when certain displacements need to be performed. The displacements of liquid fluid can thus be effected by the mechanical elements of the movement. It is also possible to use the watch wearer to actuate the liquid. In one embodiment, the liquid is transferred when the user compresses it with a particular movement, then when the freed liquid is decompressed.

The liquid or the oil of the hydraulic system can be used for lubricating gears 20, bearings, stones or other elements of the mechanical movement, continuously, on demand or automatically yet discontinuously. For this purpose, the hydraulic system 1 can include one or several nozzles or other elements for projecting the lubricant to the appropriate places.

The liquid or the oil of the hydraulic system can also be used to actuate one or several rotating or linear actuators 22, for example a cylinder, a piston, a turbine, a valve etc. These actuators can be inside the watch case or at least partly outside.

Use of a hydraulic system is particularly advantageous for transmitting considerable forces (or, equally, torques) over a considerable distance. One will use for example a hydraulic actuator to drive elements that need to move quickly, for example a date, day of the week or month disc etc. or even a retrograde hand, or other display elements performing sudden moves, including chronograph hands.

The hydraulic system can also be used to store energy, for example by compressing the fluid in a piston or a cylinder. It is for example possible to store energy during 24 hours in a cylinder released suddenly at midnight in order to make the date disc turn. One or several tubes make it possible to place the cylinder or the piston storing the energy in one place of the movement far away from where the energy is used or produced.

The hydraulic system can also be used to make the frame of a tourbillon turn along one or several axes, or for other watch complications. In the case of a watch movement provided with several regulating elements, the hydraulic system also allows the regulating element used to be switched very quickly.

The hydraulic system can also be connected to push-buttons or to the movement's crown, for example for transmitting axial or rotation movements in places removed from the button or the crown. It is for example possible to replace the stem of the crown or of a push-button by a tube, including a non-rectilinear tube, containing a liquid brought under pressure by actuating the button in order to transmit the commands from outside the case towards the movement.

Conversely, the hydraulic system can also be used for transmitting forces from inside the movement, or from a push-button, towards an element of the case or outside the case. It is for example possible to control cylinders or other actuators inside the case, or connected to the case, in order for example to open a cover, move the bezel, unfasten the wristlet-to-case straps, open the bottom etc. from an action triggered for example from the movement or from one of the push-buttons or crowns. It is also possible to automatically use push-buttons for example when the watch switches to chronograph mode, or to move a conical pinion to mesh the winding crown in different axial positions.

The liquid can also circulate between two glasses, for example between the outside glass and an inside glass, or between the dial and a glass, in order to transmit movements in an invisible manner.

The inventive movement can also include perforated flanges moved one in relation to another so as to allow liquid to pass when two holes on two flanges are opposite one another or to block this passage when the holes no longer correspond.

1. Watch or watch movement having:
a regulating element,
a display mechanism for displaying time data from the movement,
a hydraulic system for transmitting forces and/or lubricating the watch movement.

2. The watch or the watch movement of claim 1, having
a liquid reservoir,
at least one tube for bringing the liquid from the reservoir to at least one other place.

3. The watch or the watch movement of claim 2, having a reservoir cover for filling the reservoir.

4. The watch or the watch movement of claim 3, wherein said cover is accessible from outside the watch without having to open the watch.

5. The watch or the watch movement of claim 2, having a gauge for displaying the level or pressure of said liquid.

6. The watch or the watch movement of claim 5, wherein the gauge enables the level of liquid to be displayed on the watch dial.

7. The watch or the watch movement of claim 5, wherein the gauge has a hand or a disc.

8. The watch or the watch movement of claim 2, having a flexible tube.

9. The watch or the watch movement of claim 2, having a pump for circulating the liquid in the hydraulic system.

10. The watch of claim 9, wherein the pump is actuated by the watch movement.

11. The watch of claim 9, wherein the pump is directly actuated by the watch user.

12. The watch or the watch movement of claim 1, having a heat exchanger for cooling and/or heating the liquid to modify its viscosity or its volume.

13. The watch or the watch movement of claim 12, wherein the heat exchanger has one portion of hydraulic circuit close to the bottom of the watch, for heating the liquid with the wearer's body heat.

14. The watch or the watch movement of claim 12, wherein the heat exchanger has one portion of hydraulic circuit close to the watch's outer surface for cooling the liquid with ambient air.

15. The watch or the watch movement of claim 9, having at least one valve for allowing or interrupting the circulation of liquid in one portion of the hydraulic system.

16. The watch of claim 15, wherein the valve is controlled by the watch movement.

17. The watch of claim 15, wherein the valve is controlled directly by the user.

18. The watch or the watch movement of claim 1, having at least one cylinder actuating by the hydraulic system.

19. The watch or the watch movement of claim 2, having at least one expansion tank for controlling the pressure of the liquid.

20. The watch or the watch movement of claim 2, wherein
the liquid is constituted by lubricating oil,
the hydraulic system is used in order to move oil to bring it where lubrication is necessary.

21. The watch or the watch movement of claim 1, wherein the hydraulic system is used inside the movement for transmitting forces.

22. The watch or the watch movement of claim 1, wherein the hydraulic system being used for animating a complication, for example one of the following complications:
moving a date, day or month indicator;
setting the time;
driving the frame of a tourbillon;
driving an animated indicator on the dial;
selecting the regulating element used at each instant.

23. The watch of the claim 1, wherein the hydraulic system is used outside the movement.

24. The watch of claim 23, wherein the hydraulic system is used outside the watch case.

25. The watch of claim 24, wherein the hydraulic system is used for
actuating the opening of a cover,
actuating the opening of a hinged bottom,
unfastening the wristlet,
actuating the bezel,
using push-buttons
transmitting movements from a push-button or from the crown.
